(19) United States
(12) Patent Application Publication
(10) Pub. No.: US 2009/0120218 A1
(43) Pub. Date: May 14, 2009

(54) HEAD MOVING DEVICE

(76) Inventors: Naoyuki Tokuchi, Miyagi-ken (JP); Seigo Yamazaki, Iwate-ken (JP)

Correspondence Address: BRINKS HOFER GILSON & LIONE, P.O. BOX 10395, CHICAGO, IL, 60610, US

(21) Appl. No.: 12/350,016

(22) Filed: Jan. 7, 2009

(30) Foreign Application Priority Data
Jul. 14, 2006 (JP) 2006-194270

(51) Int. Cl. F16H 25/12; G11B 21/02

(52) U.S. Cl. 74/89.23

(57) ABSTRACT

A first wiring member and a second wiring member are formed of flexible wiring boards. The wiring member has a securing portion, an X extending portion, a first loop, and an X reverse portion; and the wiring member has a securing portion, an X extending portion, a first loop, and an X reverse portion. An intermediate securing portion, which is a boundary portion of the X reverse portion and a Y extending portion, and an intermediate securing portion, which is a boundary portion of the X reverse portion and a Y extending portion, are secured to an intermediate moving unit. The Y extending portions are bent at respective second loops, and head securing portions are secured to the head. When the head moves in an X direction, if the first loops move in a Y direction, the second loops move.

### CLAIM OF PRIORITY

This application claims benefit of the Japanese Patent Application No. 2006-194270 filed on Jul. 17, 2006, which is hereby incorporated by reference.

### BACKGROUND OF THE INVENTION

1. Field of the Invention

The present invention relates to a head moving device that moves a head in an X-Y plane, and to a head moving device in which a wiring member for supplying electric power or transmitting a signal is connected to the head.

2. Description of the Related Art

Various heads, such as an optical head, a print head, and a magnetic head, reciprocate linearly while facing a recording medium or a platen. When a wiring member for supplying electric power or transmitting a signal is connected to such various heads, a wiring substrate is ordinarily formed of a thin flexible wiring board.

As described in Japanese Unexamined Patent Application Publication No. 2000-251421 and Japanese Unexamined Patent Application Publication No. 2003-053975 below, flexible wiring boards each have a base portion secured to a securing-side member, such as a base, and extend in a head movement direction. In addition, the flexible wiring boards are folded through loops, and their ends are secured to the head. When the head moves linearly, the positions of the loops move, so that the flexible wiring boards can follow the moving head.

As described in Japanese Unexamined Patent Application Publication No. 2000-251421 or Japanese Unexamined Patent Application Publication No. 2003-053975, in a device in which the head reciprocates in a linear direction, the loops are formed at the flexible substrates extending in the head movement direction, to make it possible for the flexible wiring substrates to follow the movement of the head. However, in the device in which the head moves in an X direction and a Y direction, which are orthogonal to each other, with respect to the base, it is difficult for the flexible wiring boards to follow the movement of the head.

In addition, it is necessary to combine the flexible wiring board that moves in the X direction with the flexible wiring board that moves in the Y direction, thereby complicating a wiring structure.

### SUMMARY OF THE INVENTION

To overcome the aforementioned related problems, the present invention provides a head moving device, which, by using a simple structure, makes it possible for a wiring member to follow a head that moves in an X-Y direction.

The present invention provides a head moving device comprising a base; an intermediate moving unit supported at the base so as to be capable of reciprocating in an X direction; a head supported by the intermediate moving unit and capable of reciprocating in a Y direction orthogonal to the X direction; driving means for applying moving force to the intermediate moving unit and the head; and at least one wiring member having the form of a strip and extending from the base to the head. The wiring member has the following portions:

(a) a securing portion secured to a side of the base;

(b) an X extending portion extending in the X direction from the securing portion;

(c) an X reverse portion bent at a first loop from the X extending portion and reversed in the X direction;

(d) an intermediate securing portion secured to the intermediate moving unit, at an end or a portion of the X reverse portion;

(e) a Y extending portion extending in the Y direction from the intermediate securing portion and extending past the head; and

(f) a Y reverse portion bent at a second loop from the Y extending portion and reversed in the Y direction, an end or a portion of the Y reverse portion secured to the head.

In the head moving device according to the present invention, the wiring member for supplying electric power or for transmitting a signal is provided between the outside and the head. Securing the intermediate securing portion, which is an intermediate portion of the wiring portion, to the intermediate moving unit makes it possible to deform the wiring member when the intermediate moving unit moves in the X direction and when the head moves in the Y direction. In addition, the space required to deform the wiring member is small.

In the present invention, preferably, at the intermediate securing portion of the aforementioned (d), the wiring member having the form of a strip is bent substantially at right angles towards the Y extending portion from the X reverse portion, and the bent portion is secured to the intermediate moving unit.

By forming the intermediate securing portion by bending the wiring member having the form of a strip substantially perpendicularly, even if the wiring member extends linearly in the form of a strip, the wiring member can be wired to the head that moves in the X-Y direction.

For example, in the present invention, preferably, a widthwise direction of the X reverse portion of the aforementioned (c) is oriented in the Y direction, a widthwise direction of the Y extending portion of the aforementioned (e) is oriented in the X direction, the intermediate moving unit has a securing surface provided parallel to an X-Y plane, and the intermediate securing portion of the aforementioned (d) is secured to the securing surface.

In this case, the securing surface may protrude outwardly of the base, and the X extending portion of the aforementioned (b) and the X reverse portion of the aforementioned (c) may be provided at an outer side of the base.

In the above-described structure, even if the X extending portion, the X reverse portion, and the first loop are positioned outwardly of a side portion of the base, when the intermediate moving unit moves in the X direction, the first loop can move at the outer side of the side portion of the base.

Alternatively, in the present invention, a widthwise direction of the X reverse portion of the aforementioned (c) may be oriented in a direction orthogonal to an X-Y plane, a widthwise direction of the Y extending portion of the aforementioned (e) may be oriented in the X direction, the intermediate moving unit may have a securing surface provided parallel to a plane orthogonal to the X-Y plane, and the intermediate securing portion of the aforementioned (d) may be secured to the securing surface.

In the above-described structure, the X extending portion, the X reverse portion, and the first loop can be disposed between the base and a side surface of the intermediate moving unit.

In the present invention, the at least one wiring member may include a first wiring member and a second wiring member, each having the portions of the aforementioned (a) to (f), the X extending portion of the aforementioned (b) and the X reverse portion of the aforementioned (c) of the first wiring member may be provided at one side portion of the intermediate moving unit, and the X extending portion of the aforementioned (b) and the X reverse portion of the aforementioned (c) of the second wiring member may be provided at another side portion of the intermediate moving unit.

In this case, drive power may be applied to a driving section, mounted to the head, by the second wiring member, and a detection signal may be taken out from a detecting section, mounted to the head, through the first wiring member.

In the present invention, using the wiring member having the form of a strip, such as a flexible wiring board, wiring can be performed with respect to the head that moves in the X-Y plane. Moreover, when the head moves in the X-Y plane, a wiring space for the wiring member having the form of a strip does not need to be wide, so that the wiring can be efficiently performed without wires becoming tangled.

### BRIEF DESCRIPTION OF THE DRAWINGS

FIG. 1 is a perspective view of a head moving device according to an embodiment of the present invention;

FIG. 2 is a perspective view of wiring members provided at the head moving device; and

FIG. 3 is a block diagram of the structure of a head.

### DESCRIPTION OF THE PREFERRED EMBODIMENT

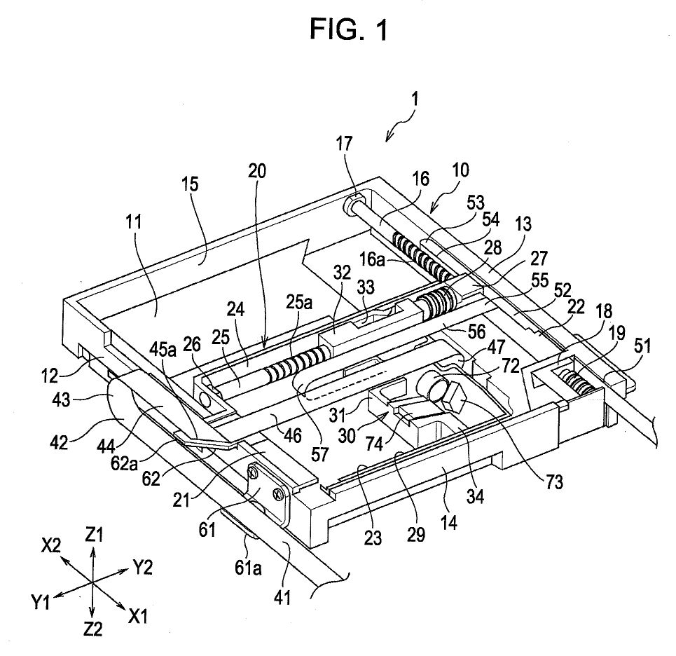

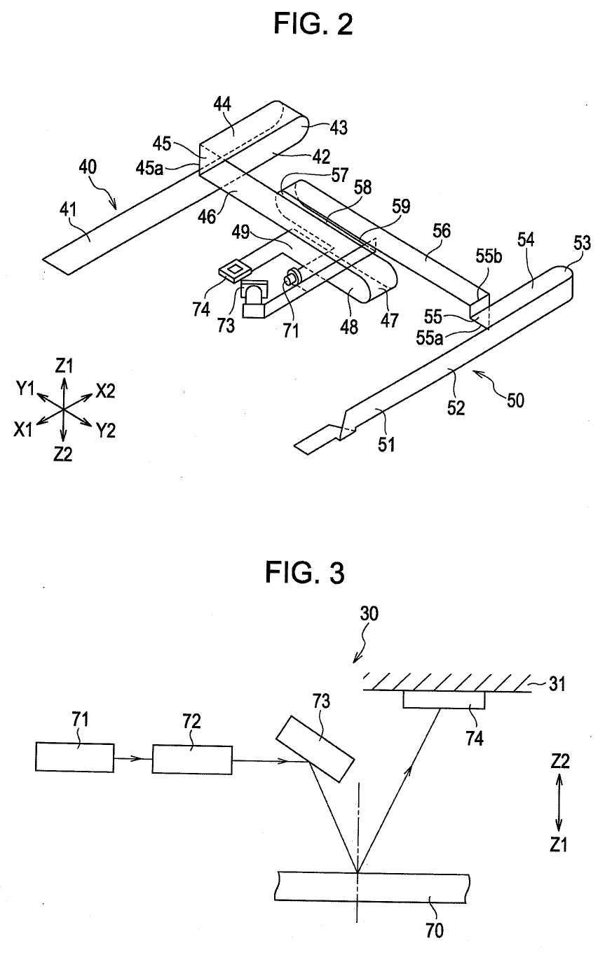

FIG. 1 is a perspective view of a head moving device according to an embodiment of the present invention. FIG. 2 is a perspective view of a pair of wiring members provided at the head moving device. FIG. 3 is a block diagram of an internal structure of the head.

The head moving device 1 shown in FIG. 1 is used in a hologram reproducing apparatus. In FIG. 1, a side facing a recording medium (Z1 direction) is shown as being in an upward direction.

The head moving device 1 includes a base 10. The base 10 is formed by, for example, die-cast molding, injection molding, or a pressing operation. The die-cast molding is performed using a light metal such as an aluminum alloy. The injection molding is performed using synthetic resin. In the pressing operation, a sheet-metal material is pressed. The base 10 has a substantially square or rectangular frame shape.

The base 10 has a flat upper plate 11 and four side plates 12, 13, 14, and 15 that surround the flat upper plate 11. The side plates 12 and 13 extend in an X-axis direction shown in FIG. 1, and the side plates 14 and 15 extend in a Y-axis direction.

An X-axis direction feed screw shaft 16 extending parallel to the side plate 13 is provided at the inner side of the side plate 13 in the base 10. The X-axis direction feed screw shaft 16 is rotatably supported by a bearing 18, provided at the side plate 14, and a bearing 17, provided at the side plate 15. A gear 19 is linked and secured to an end in an X1 direction of the X-direction feed screw shaft 16. An X-direction feed motor (not shown) is provided outwardly of the side plate 13 of the base 10. A driving force of the X-direction feed motor is transmitted to the gear 19, to rotationally drive the X-direction feed screw shaft 16.

An intermediate moving unit 20 is provided in a space surrounded by each of the side plates 12, 13, 14, and 15 of the base 10. The intermediate moving unit 20 is formed of a light metal or synthetic resin, and further has four intermediate side portions 21, 22, 23, and 24.

The X-direction feed screw shaft 16 is inserted into the intermediate side portion 22 of the intermediate moving unit 20, to guide the intermediate side portion 22 so that it can be moved in an X1-X2 direction by the X-direction feed screw shaft 16. In addition, the intermediate side portion 22 is provided with an internally threaded portion or an engaging protrusion that engages a thread groove 16a of the X-direction feed screw shaft 16. Further, the intermediate side portion 21 of the intermediate moving unit 20 is slidably supported by a guide portion provided at the side plate 12 of the base 1. When the X-direction feed screw shaft 16 is rotationally driven by the X-direction feed motor, serving as X feed driving means, the intermediate moving unit 20 moves in the X1-X2 direction by a feeding operation of the thread groove 16a.

A Y-direction feed screw shaft 25 is provided at the intermediate moving unit 20. At the inner side of the intermediate side portion 24 of the intermediate moving unit 20, the Y-direction feed screw shaft 25 extends parallel to the intermediate side portion 24. In addition, the Y-direction feed screw shaft 25 is rotatably supported by a bearing 26, provided at the intermediate side portion 21, and a bearing 27, provided at the intermediate side portion 22.

A gear 28 is linked and secured to an end portion in a Y2 direction of the Y-direction feed screw shaft 25. A Y-direction feed motor (not shown) is mounted to the inner side of the intermediate side portion 22 of the intermediate moving unit 20, and the Y-direction feed screw shaft 25 is rotationally driven by the Y-direction feed motor.

A head 30 is mounted to the intermediate moving unit 20. The base 30 has a head base 31 formed of a light metal or synthetic resin. A shaft supporting unit 32 is provided at an X2 side of the head base 31, and the Y-direction feed screw shaft 25 is inserted in the shaft supporting unit 32. An engaging member 33, formed of a leaf spring and engaging a thread groove 25a of the Y-direction feed screw shaft 25, is provided in the shaft supporting unit 32.

A slide guide unit 29 extending in the Y direction is provided at the intermediate side portion 23 of the intermediate moving unit 20, and a sliding unit 34, provided at an X1 side of the head base 31, is slidably supported by the slide guide portion 29.

When a rotational force of the Y-direction feed motor, mounted to the intermediate moving unit 20, is transmitted to the Y-direction feed screw shaft 25 through the gear 28, a feeding force of the thread groove 25a causes the head base 31 to move in a Y1-Y2 direction in the intermediate moving unit 20.

A first wiring member 40 and a second wiring member 50 are provided for being wired to the head 30 from the base-10 side. The first wiring member 40 and the second wiring member 50 are flexible strip-like wiring members. Each wiring member is, for example, what is called a flexible wiring board having lead conductors formed into a pattern on a surface of a plastic sheet, or what is called a flat cable in which a plurality of covered conductors are arranged side by side and joined. In the embodiment shown in FIGS. 1 and 2, the first wiring member 40 and the second wiring member 50 are flexible wiring boards.

As shown in FIG. 1, a securing part 61 is secured to the outer side of the side plate 12 of the base 10. A securing portion 61a of the securing part 61 extends substantially parallel to the X-Y plane, and a surface of the securing portion 61a facing a Z1 side is a securing surface.

A securing portion 41 is provided at a portion of the first wiring member 40, and is secured to the securing portion 61a by a method such as bonding. The first wiring member 40 has an X extending portion 42, which extends in the X2 direction from the securing portion 41, a first loop 43, which is bent so as to be inverted by approximately 180 degrees from the X extending portion 42, and an X reverse portion 44, which is reversed in the X1 direction continuously from the first loop 43.

The X extending portion 42 and the X reverse portion 44 are positioned substantially parallel to the X-Y plane, and widthwise directions of the X extending portion 42 and the X reverse portion 44 are Y1-Y2 directions. The first loop 43 extends along a substantially cylindrical locus with an axis parallel to the Y axis being the center.

The first wiring member 40 has an intermediate securing portion 45, formed continuously with the X reverse portion 44, and a Y extending portion 46. As shown in FIG. 2, at the intermediate securing portion 45, the strip-like wiring member is folded in two at a bending line 45a extending at an angle of 45 degrees with respect to a side thereof. The X extending portion 42, the X reverse portion 44, and the Y extending portion 46 are strip-like flexible wiring boards having the same widthwise dimension and extending linearly. At the intermediate securing portion 45, bending is performed along the bending line 45a at an angle of 45 degrees, so that the X reverse portion 44 and the Y extending portion 46 extend in directions that are substantially at right angles.

A projection 62 projecting in the Y1 direction is provided at the intermediate side portion 21 of the intermediate moving unit 20, and a surface thereof facing the Z1 side is a securing surface 62a that is parallel to the X-Y plane. In addition, the intermediate securing portion 45 is secured to the securing surface 62a with, for example, an adhesive. The securing surface 62a extending from the intermediate moving unit 20 projects outward towards a Y1 side from the side plate 12 of the base 10. Therefore, the X extending portion 42, the first loop 43, and the X reverse portion 44 of the first wiring member 40 are positioned outwardly of the side plate 12.

The Y extending portion 46 of the first wiring member 40 extends linearly in the Y2 direction by extending into the inner side of the base 10 from the securing surface 62a, and by further extending into the inner side of the intermediate moving unit 20. As shown in FIG. 1, the Y extending portion 46 is disposed as to extend past a Z1 side of the head base 31. A second loop 47, formed continuously with the Y extending portion 46, is formed towards the Y2 side than the head base 31. A Y reverse portion 48, which is folded by 180 degrees at the second loop 47, reaches a Z2-side surface of the head base 31, and a head securing portion 49 at an end of the Y reverse portion 48 is secured to the head base 31.

Surfaces of the Y extending portion 46 and the Y reverse portion 48 are substantially parallel to the X-Y plane. The widthwise direction of the Y extending portion 46 and the widthwise direction of the Y reverse portion 48 are oriented in the X1-X2 direction. The second loop 47 extends along a substantially cylindrical locus with an axis parallel to an X axis being a center.

In the first wiring member 40, when the intermediate moving unit 20 moves in the X1-X2 direction, the first loop 43 moves in the X1-X2 direction at the outer portion of the base 10, to follow the movement of the intermediate moving unit 20 without, for example, the wiring member becoming twisted. When the head base 31 moves in the Y1-Y2 direction, the second loop 47 moves in the Y1-Y2 direction by following the movement of the head base 31. Therefore, the first wiring member 40 follows the movement of the head base 31 without becoming twisted.

Securing the intermediate securing portion 45, which is a boundary between the X reverse portion 44 and the Y extending portion 46, to the intermediate moving unit 20 makes it possible to isolate bending deformation resulting from movement in the X direction from bending deformation resulting from movement in the Y direction so as not to influence each other. That is, when the first loop 43 moves in the X1-X2 direction by moving the intermediate moving unit 20 in the X direction, deformation of the first loop 43 does not directly influence the Y extending portion 46. Similarly, when the second loop 47 moves in the Y1-Y2 direction by moving the head base 31 in the Y1-Y2 direction, a bending deformation force of the second loop 47 does not directly influence the X extending portion 42 and the X reverse portion 44. In this way, even if the first wiring member 40 is formed of one wiring member, it is possible to isolate the influences of a bending deformation force resulting from the movement in the X direction and the bending deformation force resulting from the movement in the Y direction.

Next, a securing portion 51 of the second wiring member 50 is secured to the inner side of the side plate 13 of the base 10. An X extending portion 52 extending from the securing portion 51 extends in the X2 direction along the inner surface of the side plate 13 of the base 10. The second wiring member 50 is inverted by an angle of substantially 180 degrees at a first loop 53, and has an X reverse portion 54 extending in the X1 direction. As shown in FIG. 1, the X extending portion 52, the first loop 53, and the X reverse portion 54 are disposed in an area between the side plate 13 of the base 10 and the X feed screw shaft 16.

Surfaces of the X extending portion 52 and the X reverse portion 54 are oriented parallel to an X-Z plane, and a widthwise direction of the X extending portion 52 and a widthwise direction of the X reverse portion 54 are oriented in a Z1-Z2 direction. The first loop 53 extends along a cylindrical locus with an axis parallel to the Z axis as a center.

The second wiring member 50 is provided with an intermediate securing portion 55, which is bent at substantially right angles from the X reverse portion 54. The intermediate securing portion 55 is parallel to the X-Z plane, and is secured to a securing surface at the outer surface of the intermediate side portion 22 of the intermediate moving unit 20. At the intermediate securing portion 55, the second wiring member 50 is bent along a bending line 55a having an angle of 45 degrees with respect to a side thereof. In addition, the Y extending portion 56 extending from the intermediate securing portion 55 reaches the inner portion of the intermediate moving unit 20 and extends in the Y1 direction. In the second wiring member 50, the flexible wiring board has a strip form extending linearly with the same widthwise dimension from the X extending portion 52 and the X reverse portion 54 to the Y extending portion 56. By bending the strip-like flexible wiring board at the bending line 55a, the X reverse portion 54 and the Y extending portion 56 extend in directions that are substantially at right angles.

As shown in FIG. 1, the Y extending portion 56 of the second wiring member 50 extends past the Z1 side of the head base 31, extends beyond the head base 31, and extends towards a Y1 side. In addition, the Y reverse portion 58, which is bent at an angle of approximately 180 degrees at the second loop 57 from the Y extending portion 56, extends in the Y2 direction. A head securing portion 59 at an end of the Y reverse portion 58 is secured to the Z2-side surface of the head base 31.

Even in the second wiring member 50, when the intermediate moving unit 20 moves in the X1-X2 direction, the first loop 53 moves in the X1-X2 direction by following the movement of the intermediate moving unit 20. When the head base 31 moves in the Y1-Y2 direction, the second loop 57 follows the movement of the head base 31, and moves in the Y1-Y2 direction. Since the intermediate securing portion 55 is secured to the intermediate moving unit 20, deformation of the first loop 53 can be isolated from deformation of the second loop 57 so as not to influence each other.

The intermediate securing portion 55 and the Y extending portion 56 are bent at substantially right angles at a bending line 55b extending in the X1-X2 direction. Therefore, it is possible to orient the widthwise direction of the X extending portion 52 and the widthwise direction of the X reverse portion 54 in the Z1-Z2 direction, and to orient the widthwise direction of the Y extending portion 56 in the X1-X2 direction. Therefore, the X extending portion 52 and the X reverse portion 54 can be moved by deforming them in a narrow space at the inner side of the second Y side plate 13 of the base 10. By disposing the Y extending portion 56 parallel to the X-Y plane in which the head base 31 moves, the Y extending portion 56 extends in a plane at a portion in which the head base 31 moves, so that the device can be made thin.

FIG. 3 shows the structure of the head 30.

A recording medium 70 faces the Z1 side of the head moving device 1 shown in FIG. 1. The recoding medium 70 is flat, and a hologram is recorded in the recording medium 70. The head 30 includes a semiconductor-laser light-emitting element 71. Light emitted from the light-emitting element 71 is collimated by a collimator lens 72, is reflected by a galvanometer mirror 73, and illuminates the recording medium 70 as reference light. When the reference light is applied to a hologram recording portion of the recording medium 70, the reference light is diffracted by the hologram recording portion, and becomes reproduction light. Then, a planar detecting element 74, such as a CMOS, receives the reproduction light, and a processing circuit, connected to the planar detecting element, processes a signal from the planar detecting element, to reproduce information.

Movement of the head 30 in the X-Y plane makes it possible for a hologram recording portion of the recording medium 70 to be searched sequentially. Changing the angle of the reference light at the galvanometer mirror 73 makes it possible to, for example, reproduce different pages for the same hologram recording portion.

In the head moving device 1, the planar detecting element 74 is mounted to the head securing portion 49 of the first wiring member 40. The first wiring member 40 is used for transmitting a detection signal from the planar detecting element 74. Therefore, using a metallic foil or a conductive paste, a shield layer is formed on a surface of a signal-line transmission pattern formed on a surface of the flexible wiring board.

A driving section of the galvanometer mirror 73 and the light-emitting element 71 is mounted to the head securing portion 59. The second wiring member 50 is connected to the light-emitting element 71 and the galvonometer mirror 73, to supply drive power. In addition, the Y-direction feed motor, mounted to the intermediate moving unit 20, is connected to the second wiring member 50 to obtain drive power.

Although, in the embodiment, the first wiring member 40 and the second wiring member 50 are both used, either one of the wiring members may be provided at the head moving device. The head according to the present invention is not limited to a head for hologram reproduction, so that it may be, for example, a print head.

What is claimed is:

1. A head moving device comprising:
a base;
an intermediate moving unit supported at the base so as to be capable of reciprocating in an X direction;
a head supported by the intermediate moving unit and capable of reciprocating in a Y direction orthogonal to the X direction;
driving means for applying moving force to the intermediate moving unit and the head; and
at least one wiring member having the form of a strip and extending from the base to the head,
wherein the wiring member has the following portions:
(a) a securing portion secured to a side of the base;
(b) an X extending portion extending in the X direction from the securing portion;
(c) an X reverse portion bent at a first loop from the X extending portion and reversed in the X direction;
(d) an intermediate securing portion secured to the intermediate moving unit, at an end or a portion of the X reverse portion;
(e) a Y extending portion extending in the Y direction from the intermediate securing portion, and extending past the head; and
(f) a Y reverse portion bent at a second loop from the Y extending portion and reversed in the Y direction, an end or a portion of the Y reverse portion secured to the head.

2. The head moving device according to claim 1, wherein, at the intermediate securing portion of the aforementioned (d), the wiring member having the form of a strip is bent substantially at right angles towards the Y extending portion from the X reverse portion, and the bent portion is secured to the intermediate moving unit.

3. The head moving device according to claim 1, wherein a widthwise direction of the X reverse portion of the aforementioned (c) is oriented in the Y direction, and a widthwise direction of the Y extending portion of the aforementioned (e) is oriented in the X direction, and
wherein the intermediate moving unit has a securing surface provided parallel to an X-Y plane, and the intermediate securing portion of the aforementioned (d) is secured to the securing surface.

4. The head moving device according to claim 3, wherein the securing surface protrudes outwardly of the base, and the X extending portion of the aforementioned (b) and the X reverse portion of the aforementioned (c) are provided at an outer side of the base.

5. The head moving device according to claim 1, wherein a widthwise direction of the X reverse portion of the aforementioned (c) is oriented in a direction orthogonal to an X-Y plane, and a widthwise direction of the Y extending portion of the aforementioned (e) is oriented in the X direction, and
wherein the intermediate moving unit has a securing surface provided orthogonal to the X-Y plane, and the intermediate securing portion of the aforementioned (d) is secured to the securing surface.

6. The head moving device according to claim 1, wherein said at least one wiring member includes a first wiring member and a second wiring member, each having the portions of the aforementioned (a) to (f), wherein the X extending portion of the aforementioned (b) and the X reverse portion of the aforementioned (c) of the first wiring member are provided at one side portion of the intermediate moving unit, and the X extending portion of the aforementioned (b) and the X reverse portion of the aforementioned (c) of the second wiring member are provided at another side portion of the intermediate moving unit.

7. The head moving device according to claim 6, wherein drive power is applied to a driving section, mounted to the head, by the second wiring member, and a detection signal is taken out from a detecting section, mounted to the head, through the first wiring member.
